(19) United States
(12) Patent Application Publication
(10) Pub. No.: US 2016/0167453 A1
(43) Pub. Date: Jun. 16, 2016

(54) AIRCRAFT TIRE WITH DIFFERENT MODULUS PLY

(71) Applicant: The Goodyear Tire & Rubber Company, Akron, OH (US)

(72) Inventors: Kiyoshi Ueyoko, Copley, OH (US); Robert John BOEHLEFELD, Brecksville, OH (US)

(21) Appl. No.: 14/851,714

(22) Filed: Sep. 11, 2015

Related U.S. Application Data
(60) Provisional application No. 62/092,473, filed on Dec. 16, 2014.

(51) Int. Cl. B60C 15/06; B60C 5/12; B60C 15/00

(52) U.S. Cl. CPC B60C 15/06; B60C 15/0009; B60C 5/12

(57) ABSTRACT

A pneumatic tire is disclosed having two annular bead portions having a bead core. A carcass extends between the bead portions through sidewall portions and a tread portion, wherein the carcass includes at least two axially inner plies which extend down from the tread and axially inward of the bead core, said at least two axially inner plies being wound around the bead core forming respective turn-ups, each turnup being located axially outward of the bead core. The carcass further includes a first axially outer ply which extends down from the tread towards the bead core and positioned axially outward of the bead core, wherein at least one of the axially inner plies is formed from reinforcements having a higher break strength than the reinforcements of the other plies.

### FIELD OF THE INVENTION

This invention relates to pneumatic tires having a carcass and a belt reinforcing structure, more particularly to high speed heavy load tires such as those used on aircraft.

### BACKGROUND OF THE INVENTION

The radial carcass reinforcements of aircraft tires generally comprise several plies of textile cords, which are anchored to at least one annular bead member. A first group of reinforcing plies are generally wound around said annular bead member from the inside to the outside, forming turn-ups, the respective ends of which are radially spaced from the axis of rotation of the tire. The second group of plies are generally wound around the annular bead member from the outside to the inside of the tire.

Aircraft tires typically use numerous layers of ply which can significantly contribute to the tire weight. The numerous layers of ply may result in bead durability issues. It is thus desired to provide a lightweight efficient tire structure having improved bead durability. It is a further desired to provide an improved bead structure wherein the use of inside turn-up plies and outside turndown plies and their respective locations are optimized. Thus an improved aircraft tire is needed, which is capable of meeting high speed, high load and with reduced weight.

### SUMMARY OF THE INVENTION

A pneumatic tire in accordance with the present invention includes two annular bead portions, a carcass, and a belt reinforcement layer. The carcass extends between the bead portions through sidewall portions and a tread portion, wherein the carcass includes at least two axially inner plies which extend down from the tread and axially inward of the bead core, said at least two axially inner plies being wound around the bead core forming respective turn-ups, each turnup being located axially outward of the bead core; said carcass further including a first axially outer ply which extends down from the tread towards the bead core and positioned axially outward of the bead core, wherein at least one of the axially inner plies has a higher strength or higher modulus than the other plies.

### Definitions

“100 percent Modulus” means the force in mega-pascals (MPa) required to produce 100 percent elongation (e.g., stretch to two times original length).

“300 percent Modulus” or “M300 modulus” means the force in mega-pascals (MPa) required to produce 300 percent elongation (e.g., stretch to four times original length).

“Apex” means an elastomeric filler located radially above the bead core and between the plies and the turnup ply or axially outside the turnup ply.

“Annular” means formed like a ring.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread (e.g., the whole tire).

“Chafer” refers to a narrow strip of material placed around the exterior of the bead to protect bead structures from the rim, distribute flexing radially above the rim, and to better seal the tire to the rim.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). Dtex means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Gauge” refers generally to a measurement, and specifically to a thickness measurement.

“Inner” means toward the inside of the tire and “outer” means toward its exterior.

“Innerliner” means the layer or layers of elastomer or other material that form the inside surface of a tubeless tire and that contain the inflating fluid within the tire.

“Lateral” means an axial direction.

“Load Range” means load and inflation limits for a given tire used in a specific type of service as defined by tables in The Tire and Rim Association, Inc.

“Normal Load” means the specific design inflation pressure and load assigned by the appropriate standards organization for the service condition for the tire.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Sidewall” means that portion of a tire between the tread and the bead.

“Stiffness ratio” means the value of a control belt structure stiffness divided by the value of another belt structure stiffness when the values are determined by a fixed three point bending test having both ends of the cord supported and flexed by a load centered between the fixed ends.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Turnup end” means the portion of a carcass ply that turns upward (i.e., radially outward) from the beads about which the ply is wrapped.

### BRIEF DESCRIPTION OF THE DRAWINGS

The present invention will be described by way of example and with reference to the accompanying drawing, in which:

FIG. 1 is an example schematic partial cross-sectional view of a bead structure in accordance with the present invention.

FIG. 2 is an exemplary schematic showing the cable construction of the ply cords.

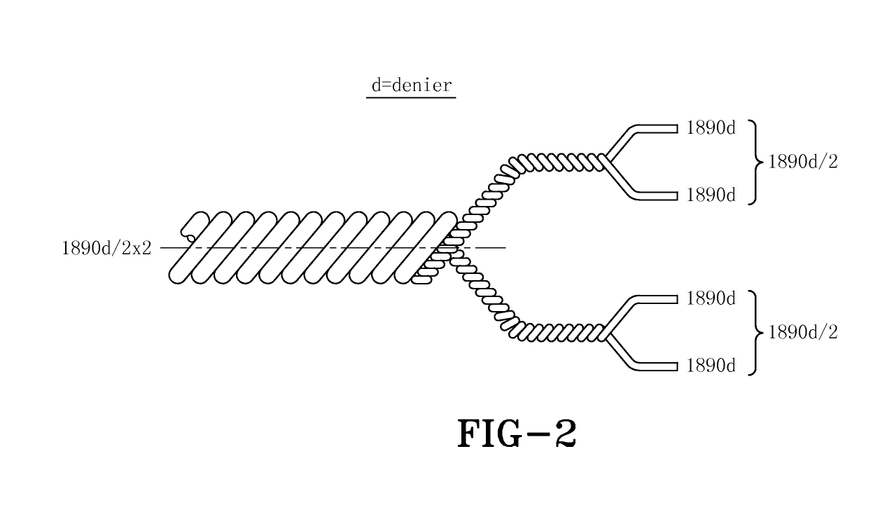

### DETAILED DESCRIPTION OF AN EXAMPLE OF THE PRESENT INVENTION

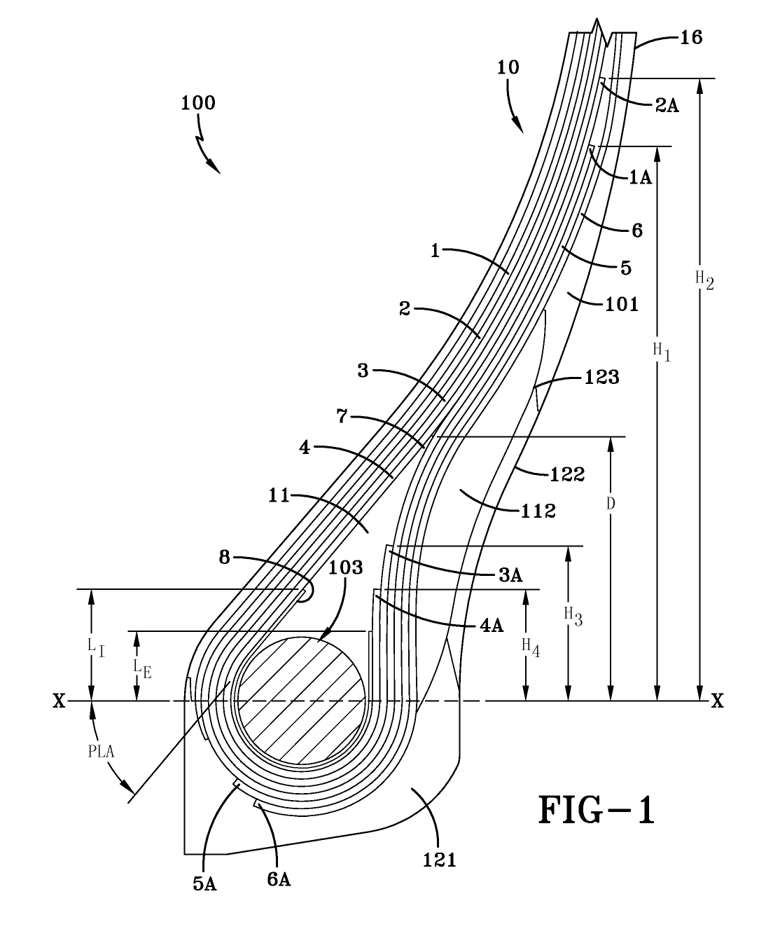

FIG. 1 schematically shows a partial cross section of an example tire bead structure 100 of a pneumatic tire in accordance with the present invention. The example tire shown is that of a standard size tire 50 x 20.0 R22 with a load rating of 57,100 pounds and a pressure rating of 220 psi. Such a structure 100 may produce excellent durability and reduced chafing at the rim. A carcass reinforcement 10 may be formed of four axially inner plies 1,2,3 and 4, and two axially outer plies 5, 6. The cross section of the bead core 103 may be radially surmounted by a filler or first apex 11 of elastomeric mix having substantially the shape of a triangle in cross-section, the terminal end 7 of which extends radially from the axis of rotation of the tire a distance D from a reference line XX extending axially through the center of the bead core. The axially inner carcass plies 1, 2, 3, 4 extend down from the tread and are positioned axially inward and are wrapped around the bead core 103, forming turn-ups 1A, 2A, 3A, 4A respectively. The turn-up 1A of the axially innermost carcass ply 1 may have its turnup end spaced radially from the line XX by the amount H1, which, for example, may be 116 mm or 1.5 times the Apex height or distance D, 56 mm. Further, for example, the turnup end 2A of the inner ply 2 may also be located radially above the terminal end 7 of the first apex 11 at distance H2 of 130 mm. Turnups 1A, 2A are preferably located radially outward of the apex tip 7, and preferably higher than the chafer ending 123 of chafer 122. Turnup 4A is preferably located radially inward of the apex tip 7. Preferably, the axially innermost ply 1 has the axially outermost turnup end 1A.

There is at least one carcass outer ply 5 that encases the turn-ups 1A, 2A, 3A, 4A, of the inner carcass plies 1, 2, 3, 4. The axially outer ply 5 may, for example, be partially wound around the bead core 103 over a portion or circular arc corresponding to an angle at the center of the circle circumscribed on the bead core 103 equal to 180° or less so that the ends 5A of the outer ply 5 is situated radially inward of the reference line XX. Preferably, there is an additional outer carcass ply 6 having an end 6A.

The plies are formed from different materials so that the axially innermost plies are formed from reinforcement cords that have a higher percent elongation at break than the axially outer carcass plies. Ply cords 1,2 are preferably formed from reinforcement cords having the highest break strength. Preferably, the reinforcement cords of ply 1,2 are formed from a nylon cable having a 1890 d/2×2 construction as shown below, i.e., formed from twisting together two sets of two1890 d yarns twisted together. Each set is twisted at 4 turns/inch in the Z direction, and then all of the yarns twisted together at 4 turns/inch in the S direction. The ply cords 1,2 are preferably formed from cable having the highest break strength and lowest elongation at break, relative to ply cords 3-6. More preferably, ply cords 1,2 have a 10-20% higher break strength than ply cords 3,4. More preferably, ply cords 1,2 have a 30-50% higher break strength than ply cords 5,6.

Ply cords 3,4 are preferably formed from reinforcements that have a higher elongation than cords 1,2 under the same load. A cord construction suitable for ply cords 3,4 are formed from a nylon cable having a 1890 d/2/2 5×6 construction, i.e., formed from a nylon cable having a 1890 d/2×2 construction as shown below, i.e., formed from twisting together two sets of two1890d yarns twisted together. Each set is twisted at 5 turns/inch in the Z direction, and then all of the yarns twisted together at 6 turns/inch in the S direction.

The down ply cords 5,6 are preferably formed from reinforcements having the highest elongation properties, and the lowest break strength, relative to ply cords 1-4. More preferably, ply cords 5,6 are formed from a nylon cable with 3 yarns having a linear density of 1890 denier, each yarn individually twisted at 6 turns/inch in the Z direction, and then all of the yarns twisted together at 6 turns/inch in the S direction.

In summary, the axially innermost carcass plies 1,2 are formed from reinforcement cables having the lowest elongation properties, and highest strength properties. Down carcass plies 5,6 are formed from reinforcement cables having the highest elongation properties and lowest strength at break. Carcass plies 3,4 are formed from cables having medium elongation properties, i.e., having higher elongation properties than plies 1,2 and lower elongation properties than plies 5,6. Carcass plies 3,4 are formed from cables having a higher break strength than carcass plies 5,6 and a lower break strength than plies 1,2.

At least one of the axially inner plies 1-4 has a M300 rubber modulus in the range of 11-19 MPa while at least one axially outer ply 5,6 has a M300 rubber modulus in the range of 20-25 MPa.

The angle of the inner plies is measured by the angle shown in FIG. 1 designated as PLA. The angle PLA is the angle between the axial direction (line X-X) and the axially outermost ply 4 of the axially inner plies 1-4, or the inner ply closest to the bead core at a location radially outward of the bead core and radially inward of the apex tip 7. Preferably, PLA ranges from 40-55 degrees as measured on a cut section of a new tire that is not mounted on a rim and is not inflated.

A flipper 8 may separate the bead core 103 from the carcass reinforcement 10 and be formed of radial textile cords identical to the carcass ply cords (or different cords). One terminal end of the flipper 8 may, for example, may extend a radial distance LI of 23 mm from the line XX. Three ends may thus be arranged radially above the terminal end 7 of the first apex 11 and be staggered between the terminal end and a location of the sidewall where the tire has a maximum axial width. The other terminal end of the flipper 8 may extend a radial distance L_{E} from the line XX equal to 13 mm.

The tire bead core 103 may be supplemented by a reinforcement ply or outer first chafer 121 reinforced with radial textile cords. The rubber chafer 121 may permit a better distribution of the pressures between the tire and its service wheel, as well as assuring protection of the carcass plies against damage upon mounting. The axially outer end of the first chafer 121 may be slightly above (about 20 mm) the reference line XX.

An example tire with a bead structure as shown in FIG. 1 may include two annular bead structures 100, a carcass 10 extending between the bead portions through two sidewall portions 101, and a tread portion (not shown). The carcass 10 may have at least one carcass ply 1 of parallel cords turned up about the bead portions 100, and a belt reinforcement layer (not shown) disposed radially outside the carcass 10 and radially inside the tread portion. Each annular bead portion 100 may include an annular bead core 103 having the carcass ply or plies 1-4 turned up around the bead core, a first apex 11 disposed adjacent and radially outward of the bead core, a second apex 112 disposed axially outward of the bead core and the carcass ply or plies, a first chafer 121 disposed adjacent the carcass ply or plies and axially outward of the bead core, and a second chafer 122 disposed adjacent and axially outward of the second apex.

The first apex 11 may be constructed of a material with a 300 percent modulus between 18-25 MPa. The second apex may be constructed of a material with a 300 percent modulus between 14-18 MPa. The first chafer 121 may be constructed of a material with a 300 percent modulus between 17-21 MPa. The second chafer 122 may be constructed of a material with a 300 percent modulus between 7-9 MPa. The axially outer end of the second chafer 122 may be about 60 mm above the line XX. The axially outer end of the second chafer 122 may thus cover the contact area between the tire and the wheel flange under a 200% rated loading condition. The sidewall portion 101 may be constructed of a material with a 300 percent modulus between 3 MPa and 8 MPa.

As stated above, a bead structure 100 in accordance with the present invention produces excellent durability and reduced chafing at the rim. This bead structure 100 thus enhances the performance of the pneumatic tire, even though the complexities of the structure and behavior of the pneumatic tire are such that no complete and satisfactory theory has been propounded.

The previous descriptive language is of the best presently contemplated mode or modes of carrying out the present invention. This description is made for the purpose of illustrating an example of general principles of the present invention and should not be interpreted as limiting the present invention. The scope of the invention is best determined by reference to the appended claims. The reference numerals as depicted in the schematic drawings are the same as those referred to in the specification. For purposes of this application, the various examples illustrated in the figures each use a same reference numeral for similar components. The examples structures may employ similar components with variations in location or quantity thereby giving rise to alternative constructions in accordance with the present invention.

What is claimed is:

1. A pneumatic tire comprising:
two annular bead portions having a bead core;
a carcass extending between the bead portions through sidewall portions and a tread portion, wherein the carcass includes at least two axially inner plies which extend down from the tread and axially inward of the bead core, said at least two axially inner plies being wound around the bead core forming respective turn-ups, each turnup being located axially outward of the bead core;
said carcass further including a first axially outer ply which extends down from the tread towards the bead core and positioned axially outward of the bead core, wherein at least one of the axially inner plies is formed from reinforcements having a higher break strength than the reinforcements of the other plies.

2. The pneumatic tire of claim 1 wherein at least two of the axially inner plies have a higher strength than the axially outer plies.

3. The pneumatic tire of claim 1 wherein the angle of the axially inner plies is in the range of 40-55 degrees as measured with respect to axis XX, when measured in the unmounted, uninflated new condition.

4. The pneumatic tire of claim 1 wherein the angle of the axially inner plies is in the range of 40-50 degrees as measured with respect to axis XX, when measured in the unmounted, uninflated new condition.

5. The pneumatic tire of claim 1 wherein the axially outermost plies are formed from nylon reinforcements having a 1890d/3 cord construction.

6. The pneumatic tire of claim 1 wherein the axially innermost plies are formed from nylon reinforcements having a 1890d/2/2 4×4 cord construction.

7. The pneumatic tire of claim 1 further comprising two additional plies located axially outward of the first and second axially inner plies, wherein said additional plies are formed of cords having a lower break strength than the first and second axially inner plies.

8. The pneumatic tire of claim 6 wherein the two additional plies are formed from nylon with a 1890d/2/2 5×6 cord construction.

9. The pneumatic tire of claim 1 wherein the axially outermost ply is formed from a lower modulus material than the axially inner plies.

10. The pneumatic tire of claim 1 wherein the axially outermost ply is formed from 1890d/3 6×6 cord construction.

11. The pneumatic tire of claim 1 wherein the axially inner carcass plies have a 5-50% higher strength than the axially outer carcass plies.

12. The pneumatic tire of claim 1 wherein the axially inner carcass plies have a 5-20% higher elongation at a specified force than the axially outer carcass plies.

13. A pneumatic tire comprising:
two annular bead portions having a bead core;
a carcass extending between the bead portions through sidewall portions and a tread portion, wherein the carcass includes at least two axially inner plies which extend down from the tread and axially inward of the bead core, said at least two axially inner plies being wound around the bead core forming respective turn-ups, each turnup being located axially outward of the bead core;
said carcass further including a first axially outer ply which extends down from the tread towards the bead core and positioned axially outward of the bead core, wherein at least one of the axially inner plies is formed from reinforcements having a lower % elongation for a given force than the reinforcements of the at least two axially outer plies.

14. The pneumatic tire of claim 1 further comprising a third and a fourth ply located axially outward of the at least two axially inner plies, wherein said third and fourth ply have a higher % elongation than the at least two axially inner plies.
